(19) United States
(12) Patent Application Publication
(10) Pub. No.: US 2013/0335292 A1
(43) Pub. Date: Dec. 19, 2013

(54) CIRCUIT BOARD HAVING ANTENNA STRUCTURE

(71) Applicant: WEI-LU HUNG, TAIPEI CITY (TW)

(72) Inventor: WEI-LU HUNG, TAIPEI CITY (TW)

(73) Assignee: ASKEY COMPUTER CORP.

(21) Appl. No.: 13/611,221

(22) Filed: Sep. 12, 2012

(30) Foreign Application Priority Data
Jun. 13, 2012 (TW) 101121080

(51) Int. Cl. H01Q 1/38; H01Q 7/00

(52) U.S. Cl. 343/866; 343/700 MS

(57) ABSTRACT

A circuit board having antenna structure for use with portable communication devices includes a substrate and an antenna body provided on the substrate. The substrate has a first, a second and a third surface that adjoin one another, and has a ground metallic element mounted thereon parallel to the third surface. The antenna body includes a radiation portion located on the first and second surfaces, a feed-in portion located on the third surface and connected to the radiation portion, and a ground portion located on the third surface and connected to the radiation portion and the ground metallic element. With these arrangements, the antenna structure provided on the circuit board overcomes the problems of limited antenna position and insufficient antenna area without being hindered by other electronic components or structural elements on the circuit board, and is operable at both higher and lower frequency bands.

### CROSS-REFERENCE TO RELATED APPLICATION

This non-provisional application claims priority under 35 U.S.C. §119(a) on Patent Application No(s). 101121080 filed in Taiwan, R.O.C. on Jun. 13, 2012, the entire contents of which are hereby incorporated by reference.

### FIELD OF TECHNOLOGY

The present invention relates to a circuit board, and more particularly to a circuit board having an antenna structure provided thereon.

### BACKGROUND

Most of the portable communication devices available in the market, such as mobile phones, notebook computers and tablet computers, include an antenna for wireless communication transmission. To enable operation at different frequency bands as specified by different communication standards, the antenna in a portable communication device must has multiple operating frequency bands, such as GSM850 which operates between 824 MHz and 894 MHz, GSM900 which operates between 880 MHz and 960 MHz, DCS which operates between 1710 MHz and 1880 MHz, PCS which operates between 1850 MHz and 1990 MHz, UMTS which operates between 1920 MHz and 2170 MHz, and WLAN/2.4 GHz which operates between 2400 MHz and 2484 MHz. In addition to the antennas that support the operating frequency bands specified by 2G/3G communication standards as mentioned above, antennas for lower operating frequency bands, such as for LTE (Long-term Evolution) 700 MHz band supporting 4G communication standards, have also been developed.

The antenna operating frequency band has relation with the length of antenna body. The lower the operating frequency band is, the longer the antenna body has to be. FIG. 1 shows a substrate 20 provided in a portable communication device. The substrate 20 has a front face 21 located parallel to a main circuit board and corresponding to a display panel of the portable communication device. Conventionally, the antenna for the portable communication device is usually a planar inverted-F antenna (PIFA) or a loop-type antenna, which is provided on the edges of the front face of the substrate, such as the positions indicated by 23, 24, 25 and 26 in FIG. 1, and these positions are located on the same plane. Due to the prevailing trend for light, slim and compact electronic products, different electronic components in the portable communication devices, such as lens, connection port and microphone, as well as different structural designs therefor all have influence on the arrangement of antenna in the portable communication devices, and the area available on the substrate 20 for the antenna is largely reduced. Meanwhile, the front face 21 of the substrate 20 is provided with a plurality of mounting holes 22 for fastening the substrate 20 to other components or an outer case. The existence of these mounting holes 22 largely limits the antenna's length, area and structure, rendering the antenna unsuitable for operating at lower frequency bands. As a result, antenna design for multiband applications is getting more and more difficult.

### SUMMARY

A primary object of the present invention is to provide a circuit board having an antenna structure, which is operable at both higher and lower frequency bands, and is therefore suitable for multiband applications to support different communication standards.

Another object of the present invention is to provide a circuit board having antenna structure, in which an antenna body is provided on three adjoining surfaces at a corner of a substrate of the circuit board to overcome the problems of limited antenna mounting position and insufficient antenna mounting area without being hindered by other electronic components or structural elements on the circuit board.

To achieve the above and other objects, the circuit board having antenna structure according to the present invention is used with a portable communication device and includes a substrate for a main circuit board to mount thereon and an antenna body provided on the substrate. The substrate has a first surface, a second surface and a third surface, any two of these surfaces are adjoining one another, and a ground metallic element is mounted on the substrate parallel to the third surface. The antenna body includes a radiation portion, a feed-in portion and a ground portion. The radiation portion is located on the first surface and the second surface, the feed-in portion is located on the third surface to electrically connect to the radiation portion, and the ground portion is located on the third surface to electrically connect to the radiation portion and the ground metallic element.

In the present invention, the substrate includes a frame portion and a supporting board portion. The first surface, the second surface and the third surface all are located on the frame portion, and the ground metallic element is mounted on the supporting board portion.

In the present invention, the radiation portion includes a first extension section, a second extension section, and a bent section connecting the first extension section with the second extension section; and the first extension section and the second extension section are laterally spaced from each other by a fixed distance. The first extension section has an end opposite to the bend section extending from the first surface to connect with the feed-in portion; and the second extension section has an end opposite to the bent section extending from the first surface or the second surface to connect with the ground portion. Preferably, the fixed distance between the first and the second extension of the radiation portion is larger than 0.1 mm; and the antenna body forms a loop-type antenna.

In the present invention, the antenna body may further include at least one frequency adjustment portion connected to the antenna body for adjusting a resonant point of the antenna structure, and the at least one frequency adjustment portion is formed of a material the same as the antenna body.

According to the present invention, the antenna body can be a thin sheet of metal material, a metal film, or a flexible printed circuit board (FPCB).

According to the present invention, the antenna body can be provided on the substrate by attaching it to the substrate via an adhesive layer, associating it with the substrate via hot melting, forming it on the substrate through laser direct structuring, or forming it on the substrate through two-component injection molding.

The circuit board having antenna structure according to the present invention is characterized by an antenna body that is provided on three adjoining surface at a corner of the substrate of the circuit board in the portable communication device without being hindered by other electronic components or structural elements that are also mounted on the circuit board. Therefore, the present invention overcomes the problems in the prior art portable communication devices, such as limited position and insufficient area for antenna on the circuit board, and is suitable for an antenna structural design intended for lower operating frequency band. In brief, the circuit board having antenna structure according to the present invention has both high and low operating frequency bands to satisfy multiband applications under different communication standards.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a substrate inside a portable communication device and positions on the substrate for an antenna structure;

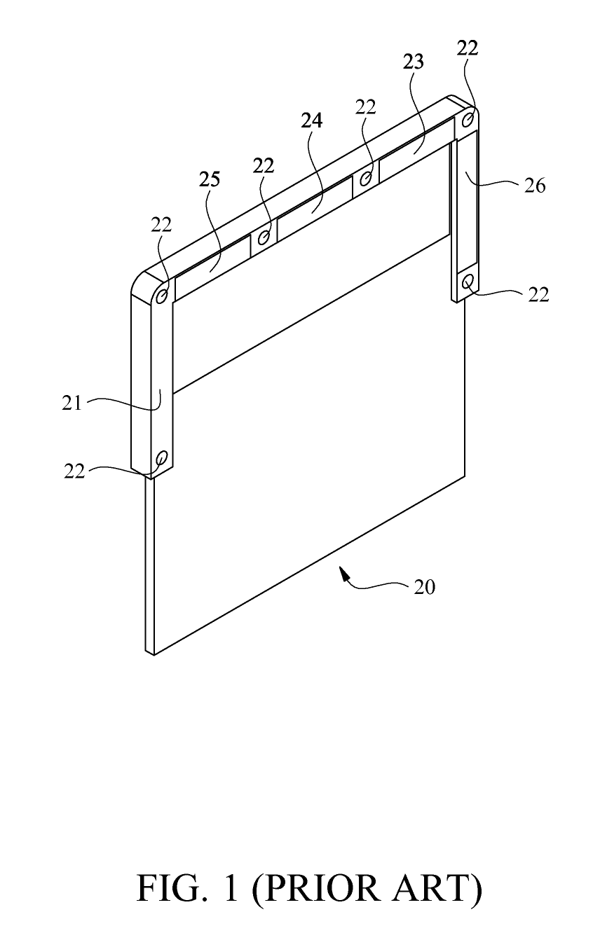

FIG. 2 schematically shows a circuit board having antenna structure according to a preferred embodiment of the present invention;

FIG. 3 schematically shows the circuit board according to the preferred embodiment of the present invention with the antenna structure thereof being configured in a different manner; and

FIG. 4 schematically shows the circuit board according to the preferred embodiment of the present invention with the antenna structure thereof further including a frequency adjustment portion.

### DETAILED DESCRIPTION

The present invention will now be described with some preferred embodiments thereof and with reference to the accompanying drawings. For the purpose of easy to understand, elements that are the same in the preferred embodiments are denoted by the same reference numerals.

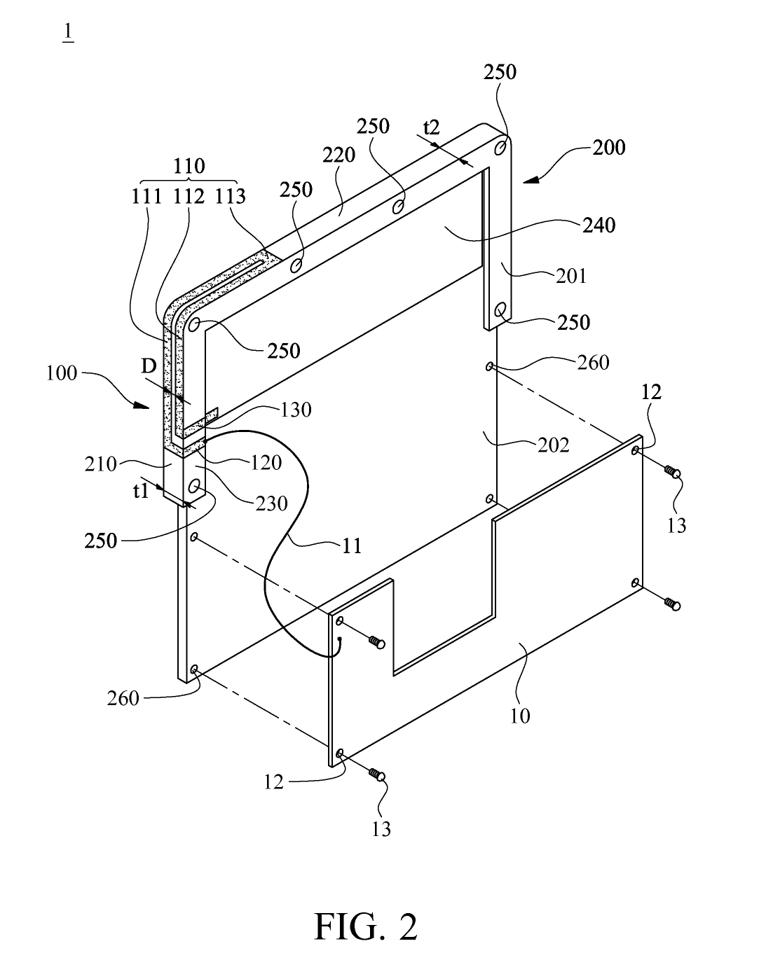

Please refer to FIG. 2 that is a schematic view of a circuit board having antenna structure according to a preferred embodiment of the present invention. For the purpose of conciseness, the present invention is also briefly referred as “the circuit board” herein and is generally denoted by reference numeral 1. As shown, the circuit board 1 is used with a portable communication device and includes a substrate 200 and an antenna body 100. The substrate 200 provides a place for a main circuit board 10 to mount thereon, and includes a first surface 210, a second surface 220 and a third surface 230. Any two of the three surfaces 210, 220, 230 are located adjoining one another. A ground metallic element 240 is mounted on the substrate 200 parallel to the third surface 230. The antenna body 100 is provided on the substrate 200 and includes a radiation portion 110, a feed-in portion 120 and a ground portion 130. The radiation portion 110 is located on the first surface 210 and the second surface 220; the feed-in portion 120 is located on the third surface 230 to electrically connect to the radiation portion 110, and is also electrically connected to the main circuit board 10 via a feed wire 11; and the ground portion 130 is located on the third surface 230 to electrically connect to the radiation portion 110 and the ground metallic element 240. For example, the feed wire 11 can be an RF coaxial cable, which includes a central copper wire, an insulation surrounding the copper wire, an outer conductor surrounding the insulation and forming an outermost layer of the RF coaxial cable. Generally, the outer conductor is a thin layer of copper or copper alloy mesh. Wherein, the RF coaxial cable is electrically connected at one end to the main circuit board 10 and at another opposite end to the feed-in portion 120 via the copper wire. Further, the outer conductor of the RF coaxial cable can be electrically connected to the ground portion 130 or the ground metallic element 240 to achieve grounding effect.

As can be seen in FIG. 2, the substrate 200 provides a place for mounting the main circuit board 10 and various electronic components in the portable communication device, such as lens, connection port and microphone. The substrate 200 is provided with mounting holes 250, 260, via which the main circuit board 10, other electronic components and an outer case (not shown) of the portable communication device can be fastened to the substrate 200. For example, the main circuit board 10 is mounted to the substrate 200 by threading screws 13 through screw holes 12 provided on the main circuit board 10 and the mounting holes 260 provided on the substrate 200. For any two of the three surfaces 210, 220, 230 of the substrate 200 to adjoin one another, the first, second and third surfaces 210, 220, 230 are located corresponding to two adjoining side surfaces and a front surface at one corner of the portable communication device. The front surface, i.e. the third surface 230, has the largest area on the substrate 200 and is parallel to the main circuit board 10 and a display panel (not shown) of the portable communication device. The two adjoining side surfaces, i.e. the first surface 210 and the second surface 220, have smaller areas compared to the front surface. Further, the first surface 210 and the second surface 220 are substantially perpendicular to the third surface 230. That is, the first surface 210 and the second surface 220 are located corresponding to two side surfaces of the portable communication device. In FIG. 2, the substrate 200 is illustrated as including a relatively thicker frame portion 201 and a relatively thinner supporting board portion 202. In the present invention, the first surface 210, the second surface 220 and the third surface 230 are located on the frame portion 201, and the ground metallic element 240 is mounted on the supporting board portion 202. With the frame portion 201, sufficient side surface areas can be obtained for arranging the antenna body 100 thereon. However, the substrate 200 can be otherwise a single board with the ground metallic element 240 directly mounted on the third surface 230. Alternatively, according to another embodiment of the substrate 200, the ground metallic element 240 is a metal plate directly mounted to the frame portion 201, and the main circuit board 10 is then mounted on the ground metallic element 240. Moreover, as can be seen in FIG. 2, the corner at where the first surface 210 and the second surface 220 converge is a rounded corner to form a curved surface, which extends from the first surface 210 to the second surface 220.

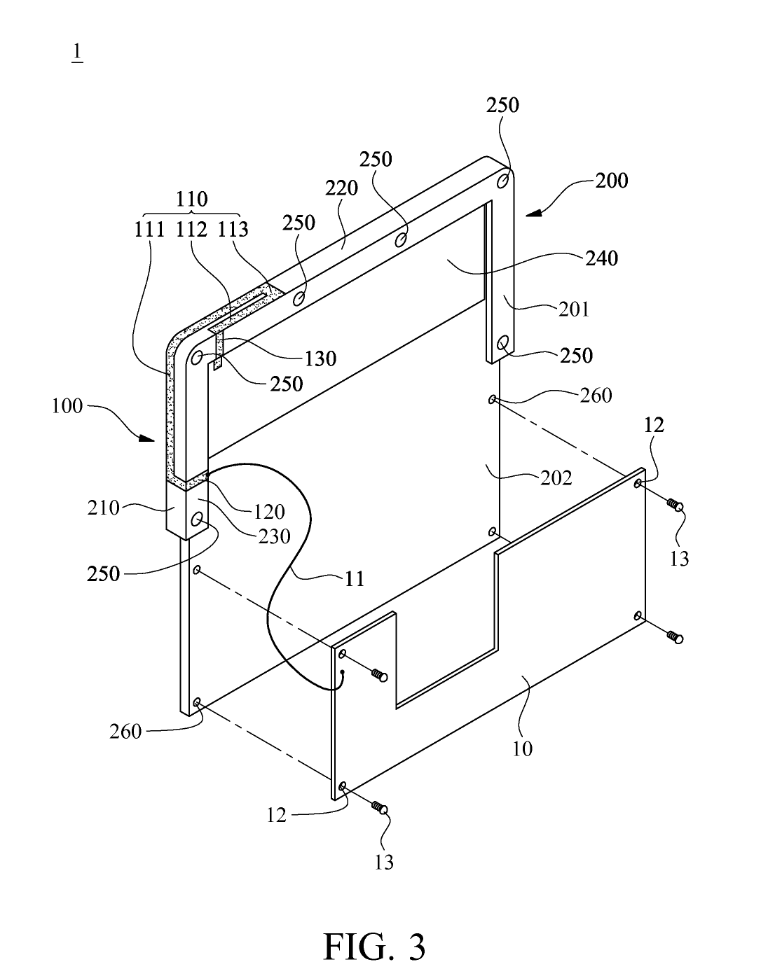

In the circuit board 1 according to the preferred embodiment of the present invention, the radiation portion 110 includes a first extension section 111, a second extension section 112, and a bent section 113 connecting the first extension section 111 with the second extension section 112. It is noted the first extension section 111 and the second extension section 112 are laterally spaced from each other by a fixed distance D. As can be seen in FIG. 2, the first extension section 111 has an end opposite to the bent section 113 extending from the first surface 210 to connect with the feed-in portion 120, and the second extension section 112 also has an end opposite to the bent section 113 extending from the first surface 210 to connect with the ground portion 130. In other words, the radiation portion 110 is turned around on the second surface 220 to form the bent section 113. That is, the bent section 113 is located on the second surface 220, and the second extension section 112 connected to an end of the bent section 113 is extended from the second surface 220 to the first surface 210 before it finally connects with the ground portion 130. Thus, the antenna structure on the circuit board 1 in the preferred embodiment of the present invention satisfies a loop-type antenna operable in a resonant mode. Alternatively, as in another design shown in FIG. 3, the first extension section 111 has an end opposite to the bent section 113 extending from the first surface 210 to connect with the feed-in portion 120 while the second extension section 112 has an end opposite to the bent section 113 extending from the second surface 220 to connect with the ground portion 130. In other words, the radiation portion 110 is turned around on the second surface 220 to form the bent section 113. That is, the bent section 113 is located on the second surface 220, and the second extension section 112 connected to an end of the bent section 113 is extended from the second surface 220 to connect with the ground portion 130 on the third surface 230.

The antenna body according to the present invention is not limited to the form of a loop-type antenna but can be other types of antenna, such as a planar inverted-F antenna (PIFA) having extended radiation portions to cover both high and low operating frequency bands. Compared to the loop-type antenna, the PIFA advantageously having a size only about one-half of the loop-type antenna and is therefore suitable for use with lightweight, slim and compact portable communication devices.

In the circuit board having antenna structure according to the preferred embodiment of the present invention, the radiation power of the antenna structure has relation with the area of the radiation portion 110. The larger the area of the radiation portion 110 is, the higher the radiation power of the antenna structure will be. In FIG. 2, the radiation portion 110 has an area defined by a width t1 of the first surface 210, a width t2 of the second surface 220, the fixed distance D, and a length by which the radiation portion 110 extends. Given the width t1 of the first surface 210, the width t2 of the second surface 220 and the overall length of the radiation portion 110 are determined, the first extension section 111 and the second extension section 112 would have an increased total area and the antenna structure would have higher radiation power when the fixed distance D between the first extension section 111 and the second extension section 112 is reduced. In the present invention, the fixed distance D is larger than 0.1 mm and preferably larger than 0.2 mm; and the width t1 of the first surface 210 and the width t2 of the second surface 220 are ranged from 3 mm to 10 mm.

Further, the operating frequency band of the antenna structure has relation with an overall length of the antenna body 100. For lower operating frequency band, the antenna body 100 requires a longer overall length. For example, when the preferred embodiment of the present invention has an antenna designed for operating within the low frequency band of 700 MHz, the antenna body 100 should have an overall length about 10 to 32 cm. That is, the total extension length of the first extension section 111, the bent section 113 and the second extension section 112 of the radiation portion 110 is about 10 to 32 cm.

In the preferred embodiment of the present invention, the antenna body 100 is a thin sheet of electrically conductive metal material, such as copper foil or iron sheet, being attached to the substrate 200 via an adhesive layer, such as a layer of gum. Alternatively, the antenna body 100 can be associated with a plastic substrate 200 by way of hot melting. The antenna body 100 can be a flexible printed circuit board (FPCB) for flexibly attaching to the first surface 210, the second surface 220 and the third surface 230. Alternatively, the antenna body 100 can be a metal film being directly formed on the substrate 200 by means of laser direct structuring or two-component injection molding.

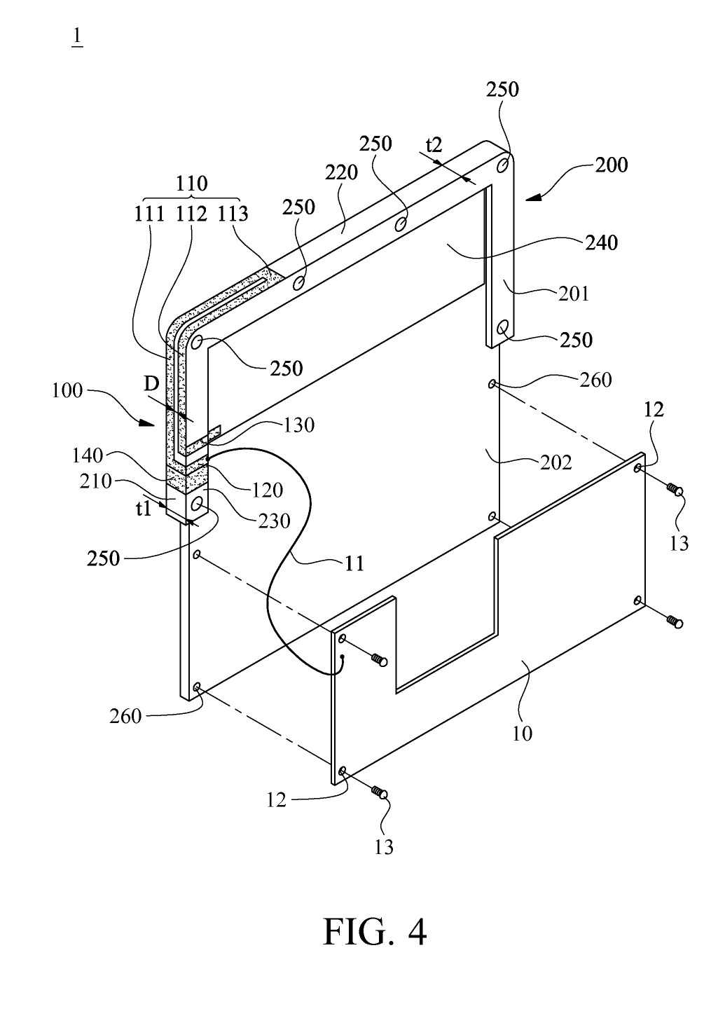

Please refer to FIG. 4. In the circuit board having antenna structure according to the preferred embodiment of the present invention, the antenna body 100 may further include a frequency adjustment portion 140 for adjusting the operating frequency band of high-frequency. The frequency adjustment portion 140 is formed of a material the same as that of the antenna body. In the illustrated preferred embodiment, the frequency adjustment portion 140 is located adjoining a position at where the radiation portion 110 and the feed-in portion 120 connected to each other. The frequency adjustment portion 140 is formed of a material the same as that of the antenna body 100 for adjusting the resonant path or the resonant area of the antenna structure. The exact position and size of the frequency adjustment portion 140 provided on the antenna body 100 are decided according to the required antenna operating frequency band or the structural shape of the antenna body 100. Therefore, in practical design of the antenna body, more than one frequency adjustment portion can be provided without being limited to that shown in the illustrated and described preferred embodiment. In the preferred embodiment of the present invention, the antenna body 100 can be finely adjusted via the frequency adjustment portion 140 for the antenna structure to operate at required higher frequency bands, which are resonant harmonics as multiples of a fundamental frequency within a lower frequency band. For example, when the antenna structure has a lower operating frequency band, such as LTE 700 MHz band, the harmonics thereof are multiples of the fundamental frequency of 700 MHz, including 1400 MHz, 2100 MHz, 2800 MHz, etc. The frequency adjustment portion 140 can be used to adjust the higher frequency operating bands of the antenna structure without influencing the lower operating frequency resonant band of the antenna structure, so that the adjustment of the operating bands of the antenna structure can be more easily performed.

The circuit board having antenna structure according to the present invention is characterized by an antenna body that is provided on three adjoining surface at a corner of the substrate of the circuit board in the portable communication device without being hindered by other electronic components or structural elements that are also mounted on the circuit board. Therefore, the present invention overcomes the problems in the prior art portable communication devices, such as limited position and insufficient area on the circuit board for antenna, and is suitable for an antenna structural design intended for lower operating frequency band. In brief, the circuit board having antenna structure according to the present invention has both high and low operating frequency bands to satisfy multiband applications under different communication standards.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A circuit board having antenna structure for use with a portable communication device, comprising:
a substrate for a main circuit board to mount thereon; the substrate having a first surface, a second surface and a third surface, any two of these surfaces being adjoining on another; and a ground metallic element being mounted on the substrate parallel to the third surface; and
an antenna body being provided on the substrate, and including a radiation portion, a feed-in portion and a ground portion; the radiation portion being located on the first surface and the second surface, the feed-in portion being located on the third surface to electrically connect to the radiation portion, and the ground portion being located on the third surface to electrically connect to the radiation portion and the ground metallic element.

2. The circuit board having antenna structure as claimed in claim 1, wherein the substrate includes a frame portion and a supporting board portion; the first surface, the second surface and the third surface all being located on the frame portion, and the ground metallic element being mounted on the supporting board portion.

3. The circuit board having antenna structure as claimed in claim 1, wherein the radiation portion includes a first extension section, a second extension section, and a bent section connecting the first extension section with the second extension section; and the first extension section and the second extension section being laterally spaced from each other by a fixed distance.

4. The circuit board having antenna structure as claimed in claim 3, wherein the first extension section has an end opposite to the bend section extending from the first surface to connect with the feed-in portion; and the second extension section has an end opposite to the bent section extending from one of the first surface and the second surface to connect with the ground portion.

5. The circuit board having antenna structure as claimed in claim 3, wherein the fixed distance between the first and the second extension of the radiation portion is larger than 0.1 mm.

6. The circuit board having antenna structure as claimed in claim 3, wherein the antenna body forms a loop-type antenna.

7. The circuit board having antenna structure as claimed in claim 1, wherein the antenna body further includes at least one frequency adjustment portion connected to the antenna body for adjusting a resonant point of the antenna structure.

8. The circuit board having antenna structure as claimed in claim 1, wherein the antenna body is selected from the group consisting of a thin sheet of metal material, a metal film, and a flexible printed circuit board.

9. The circuit board having antenna structure as claimed in claim 8, wherein the antenna body is provided on the substrate in a manner selected from the group consisting of being attached to the substrate via an adhesive layer, being associated with the substrate via hot melting, being formed on the substrate through laser direct structuring, and being formed on the substrate through two-component injection molding.
